(19) United States
(12) Patent Application Publication
(10) Pub. No.: US 2005/0203755 A1
(43) Pub. Date: Sep. 15, 2005

(54) Method, system and program for integrated service management

(75) Inventor: Sridhar Krishnamoorthy, Edison, NJ (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 10/796,345

(22) Filed: Mar. 9, 2004

(51) Int. Cl. G06F 17/60

(52) U.S. Cl. 705/1

(57) ABSTRACT

Disclosed are a method, system program for providing equipment service data. The method includes the steps of creating a database containing a plurality of equipment service data elements, providing an access point for a user to access the database, verifying that the user is authorized to access the database, and providing access to the database over a secure network if the user is authorized to access the database. For example, the plurality of equipment service data elements comprise data elements regarding at least one of: sales, customer history, equipment history, warranties, service calls, preventive maintenance, repairs, spare parts, accounts receivable, and accounts payable. Also, preferably, the user comprises at least one of: a customer, a potential customer, and a franchisee.

### BACKGROUND OF THE INVENTION

1. Field of the Invention

This invention generally relates to service management, and more specifically, to methods and systems for providing service data.

2. Background Art

At the present time, there are no complete and appropriate solutions for the service businesses, especially for integrating service networks of major original equipment manufactures (OEMs). The current solutions are underdeveloped, patchy and not matured. A new solution that will address all the needs of the service after sales is required.

Many manufacturing companies concentrate on manufacturing and equipment sales, and allow service to be taken care of by the dealers and third parties. Except for a few companies, there are no adequate efforts to develop the company Service infrastructure or to concentrate on Service revenues. Most companies look upon Service Management as an unpleasant job that is very labor intensive, difficult to manage, and, basically, not worth the effort.

In the case of high tech electronics and medical equipment, where the service revenues are higher and government regulations are stringent, third party service participation is less. One reason for this is that the high tech customers want to deal directly with the manufacturers and do not want to take chances with third parties. Because of this, any third party who wants to provide service should be highly qualified and should constantly update their knowledge with the changing technology. This requires a close working relationship with the original equipment manufacturers.

For a number of reasons, manufacturers should now focus on the service business. First, there are significant income opportunities. Manufacturers have outsourced many of their operations to reduce cost, and they are realizing that they cannot lower the cost of products anymore. Now, it is time to look at the long ignored revenue stream from Service.

Managing dispersed service delivery process has forced the manufacturers to learn more about dissecting the Value chain. Manufacturers are realizing that a good service management system can eliminate time and cost from service delivery cycles and significantly improve profitability. Service needs a local presence, and many service jobs cannot be outsourced overseas. Thus, Service will be a continuous source of revenue in the future, and the service jobs are here to stay. Also, consolidation, alliances, takeovers, mergers and partnerships in Service business will happen soon.

At the same time, a number of challenges are facing OEMs who want to focus on service business. Specifically, in tapping the Service revenue stream, the OEMs face the following challenges: competing with low cost third party service providers, reducing the cost of operations and improving profitability, improving business growth, maintaining information flow, extending equipment useful life and providing new technology features, keeping equipment down time at a minimum, offering a competitive edge through overwhelming customer Service at a lower cost, catering to a large geographical area with limited resources, reducing spare parts inventory costs without compromising Service Quality, and maintaining an optimum level of resources and efficient resource planning.

As a result of the foregoing, the Service industry is becoming e-Enabled. Many companies can earn more than 50% of their revenue through after sales service and have realized that Customer Service also offers a competitive edge and keeps them in constant touch with the customer. An important focus is to computerize the customer service operations and e-enable transactions like service contract sales, call handling, spares sales, franchisee management and knowledge management. It is also important to collect data on customer, usage pattern, product quality, competitors, etc, using a service network. Additional important considerations are to reduce the cost of service operations by establishing “service franchisee network,” to improve service profitability, and to measure customer satisfaction.

An important trend is a move towards Service Franchising. To reduce service operation cost and fixed costs, many companies are establishing a service franchisee network. Service franchise is another forward step from service dealership and it may follow the guidelines as below.

Specifically, a service franchisee is authorized to sell service contracts, perform service and sell spares to the end customer; a service franchisee can be appointed to work on fixed or variable service rates determined and paid by the company (OEM) or the OEM is paid a certain percentage as commission and the rest is taken by the franchisee; the service franchisee is paid a commission for the service contracts sold by him; and the service franchisee can be a service organization or a third party individual who will perform services for the end customer.

With Service Franchising, the payments from the customer for service contracts, T&M etc. are collected directly by the OEM, and the franchisee gets paid periodically by the OEM based on the services rendered and value of the contract sold. The service calls are centralized through a customer interaction center that takes the customer calls through phone, fax, and Internet, and the service calls are assigned and dispatched to the franchisee. A service franchisee can also use a Hub-Spokes sub network to penetrate deeper into small towns. The service franchisee will be constantly trained technically and professionally by the OEM. The service franchisee network offers better area of coverage and good returns with a small service management team that is e-enabled. Service franchising reduces the high cost manpower requirement of OEMs and encourages local self employment and profit sharing.

There are significant challenges with the current service repair process. For the OEM, there are too many people involved, too many different IT systems, it is too hard to identify urgent, new problems, and too much time is spent on phone calls, faxes, etc. Also, there are too few details to make good product decisions, too little protection against fraud, too many files to cross-reference and update, too little quality data to analyze effectively, and too high costs.

From the point of view of the service franchisee, it is too hard to get real-time repair authorizations, too much work to get any repair authorization, too much time spent on phone calls, faxes, etc., and too much data-entry (including double-entry). It is too hard to get copies of service manuals, too hard to get technical support, and too little time is available to train on new products. There is too little information on replacement parts availability, too much paperwork and it takes too long to wait for reimbursement.

One important goal of a Service management business is the improved coordinating/management of the Service Franchisee. A number of more specific goals may be set. These include eliminate human intervention required to: identify warranty or extended warranty coverage; authorize covered work; provide unit-specific repair history (including work done by other 3rd parties); collect meaningful field failure data; provide access to tech manuals & technical support; check availability, enter orders & check order status of replacement parts; and process reimbursement requests for covered work. Additional goals include to provide improved fraud protection for OEMs, better manage replacement part inventories/planning, improved warranty cost tracking/reporting/analysis for OEMs, and reduced field failure exposure caused by slow problem recognition.

OEMs face specific business needs in the new world. These include a clear service vision, strategy and business plan, a well defined “service value chain,” a strong service establishment with well defined systems and procedures, end to end customer call tracking and escalation procedures, and a high contract hit percentage. Additional OEM business needs include knowledge management and training, customer visibility across the organization, formulate and maintain high service quality levels, and quicker response times, turn around times and billing times.

Third party Service businesses also face specific needs in the new world. These include establishing strong roots in business, a steady revenue stream and cash flow, assured profitability, personal and professional growth, knowledge management, and business growth. Additional needs of third party service businesses include knowledge management and training, timely payments, formulate and maintain high service quality levels, quicker response time, and turn around times and billing times.

Overall service business needs include lowering direct employment costs and fixed costs, centralized service contract sales control using technology, centralized customer call management, e-enabled warranty management (automatic warranty tracking and approvals), and centralized and automated billing. Further needs include e-enabled price negotiations, web based training for service franchisee, knowledge network for franchisee and solution database, on-line spare parts catalogs, spares parts management, and service franchisee management.

### SUMMARY OF THE INVENTION

An object of this invention is to provide a complete solution that addresses all of the needs of the service after sales.

Another object of the invention is to integrate back office, front office, web and wireless technology for the total management of customer service to enable collaboration between OEMs, service providers, and suppliers.

These and other objectives are attained with a method and system for providing equipment service data. The method comprises the steps of creating a database containing a plurality of equipment service data elements, providing an access point for a user to access the database, verifying that the user is authorized to access the database, and providing access to the database over a secure network if the user is authorized to access the database.

For example, the plurality of equipment service data elements comprise data elements regarding at least one of: sales, customer history, equipment history, warranties, service calls, preventive maintenance, repairs, spare parts, accounts receivable, and accounts payable. Also, preferably, the user comprises at least one of: a customer, a potential customer, and a franchisee.

The preferred embodiment of the invention, described below in detail, offers a total solution for the OEMs, their service dealers and franchisees. The invention, in its preferred embodiment, offers a virtual private office space for all the nodes or franchisees in the network and integrates the essential data across the entire network. This helps the OEMs to increase the service revenue, better capture of customer and equipment history, improve turn around times, increase profitability, spares management, warranty administration and customer satisfaction.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a flow chart showing a preferred embodiment of the invention.

FIG. 2 illustrates a physical network and processes that may be used in the implementation of this invention.

FIG. 3 shows an example of how the invention may be used.

### DETAILED DESCRIPTION OF THE PREFERRED EMBODIMENTS

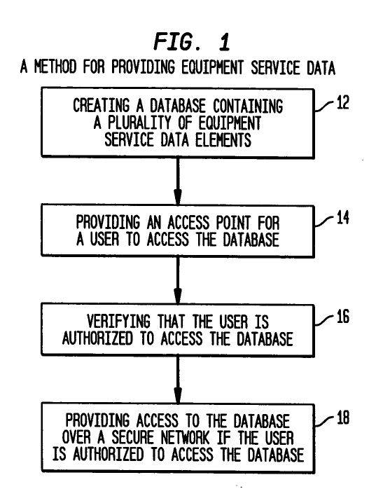

The present invention, generally, provides a method and system for providing equipment service data. With reference to FIG. 1, this method comprises the steps 12 and 14 of creating a database containing a plurality of equipment service data elements, and providing an access point for a user to access the database. The method comprises the further steps 16 and 18 of verifying that the user is authorized to access the database, and providing access to the database over a secure network if the user is authorized to access the database.

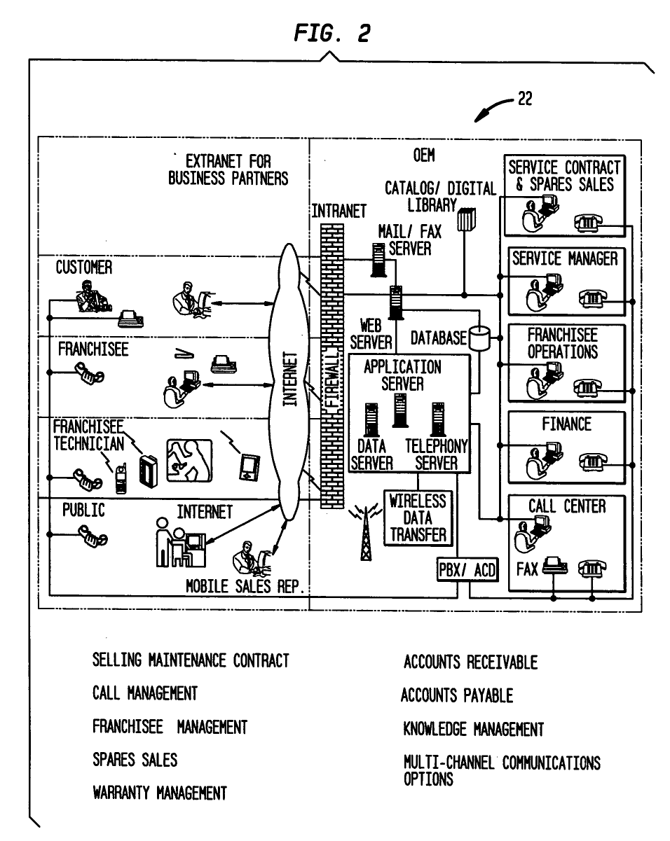

The invention is a process and technology solution. Once the specific physical network and the specific processes are defined, the processes are enabled by the Web based Technology. With reference to FIG. 2, this network may integrate the OEMs 22, like Equipment manufacturers, Consumer electronics, Medical electronics and appliances manufacturers, with their service franchisees and dealers. When the OEMs have an uninterrupted flow of information from and to the service franchisees, the franchisees immensely benefit by getting a virtual office space in the network, where he can perform his day to day transactions like Sales, Preventive maintenance, Service call handling, Spares sales, billing and accounting. This also can be offered as a Business Technology outsourcing solution (BTO) by a provider, who can design, build and operate networks for their clients.

The invention can be used to provide many specific types of services. For instance, again with reference to FIG. 2, the invention may be used for selling maintenance contract, call management, franchisee management, spares sales, warranty management, accounts receivable, accounts payable, and knowledge management.

Preferably, the invention is a cross application network that integrates back office, front office, web and wireless technology for the total management of customer service to enable collaboration between OEMs, service providers, and suppliers.

Also, preferably, the invention is designed to interface Internet Enabled Equipment and Appliances (IEE) triggered by a repair event. This enables an Early Warning System (EWS) to offer predictive and need based repair service. IEE interfaces may also be used to help study equipment usage and failure patterns that will help in design improvements and new product designs. The invention may include algorithms (rules/conditions) that help determine how a product repair is handled. After the transaction is completed, information may be fed back to the underlying systems that maintain product/service information.

Any suitable individual components or modules may be used in the practice of this invention. Suitable modules may be provided by SAP and Siebel. For example, the SAP modules that may be used are SD, MM FICO, Portals, BW, CRM Service R/3 Customer Service, Siebel, Remedy, and Clarify. A Siebel Call centre/SAP CRM can be used for Call Management. The invention can be variant configured to the varying needs of small scale, medium scale and large scale organizations. Using the present invention, an organization can fulfill the customer needs by integrating existing systems and new functional components to enable an integrated after sales service/repairs/warranty management process. Also, the invention can be offered as part of a BTO solution for the service Business, and can be offered to clients as Build, Operate and Hand-Over or Build, Operate and Maintain.

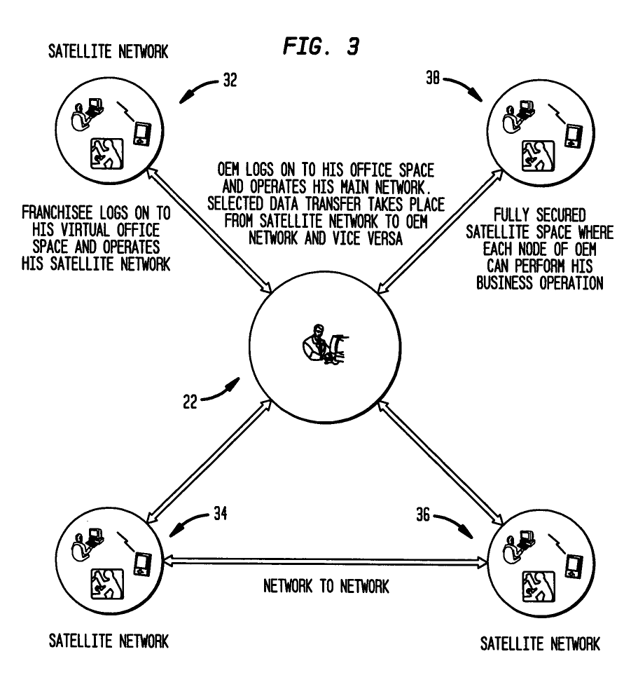

FIG. 3 illustrates an example of how the invention may be used. This Figure shows an OEM 22 and satellite networks 32, 34 and 36. In the method, a franchisee at 32 logs on to his virtual office space and operates his satellite network. The OEM logs on to his office space and operates his main network. Selected data transfer takes place from the Satellite network to the OEM network and vice versa. As represented at 38, each node of the OEM may be provided with a fully secured satellite space, where business operations can be performed.

The invention can be used to fulfill many needs, including: centralized and automated billing, warranty management, E-enabled price negotiations, centralized call management, web based training for service franchisee, knowledge network for franchisee and solution database, spares catalog, spare parts management, service franchisee management, invoicing (contracts and T & M), accounts receivable and accounts payable, and resource assignment based on skill sets.

The present invention may be used to help achieve a number of client objectives, including cost reduction, variability, scalability, strategic focus, and speed. Cost reduction can be achieved by changing the existing corporate governance model to enable cost efficiencies to be achieved through centralization of work activities, process standardization, and process excellence. Variability is obtained in that the invention enables a client's business, and the corporation in general, to view support processes in a more variable manner. Scalability is attained because the invention supports process operating models that can withstand the anticipated scale changes that are expected to occur over the next several years.

Improved strategic focus is achieved in that the invention supports client management's drive to change the cultural mindset within corporate support functions—from activity and operations-based to one where management focuses on strategic investment and value creation opportunities. Also, increased speed is achieved because the invention positions support service transformation as an integral part of the broad client value story and delivers the new operating models in an expeditious manner to support earnings objectives.

The preferred embodiment of the invention, as described above in detail, provides important benefits for end customers, OEMs, and service franchisees. Key benefits for the end customer include flexibility, lower repair bills, improved response time, reduced downtime, real-time access to service request/call status information, improved communication, on time service renewal (no lapse), new products and services, 24×7 coverage, reduced interruptions, support for personalized and customized products, and increased satisfaction and peace of mind.

Significant benefits to the OEMs include increased revenue and profits, faster service, new products and services, reduced phone contact, reduced administrative costs, efficient and quality franchisee network, supports high volume, minimizes staffing needs, supports near real-time call status, defends market leadership, real-time information sharing and processing, business process simplification, increased franchisee satisfaction, ability to manage/monitor service performance, faster communication, and customer satisfaction.

Among the key benefits for the service franchisees are: increased revenue and profits, improved information, new products and services, reduced phone contact, reduced administrative costs, supports high volume, eliminates non-value added tasks, real-time information sharing, increased satisfaction, reduced labor costs, ability to manage/monitor performance, faster communication, reduced costs, access to knowledge and experience, fixed rate billing, minimizes staffing needs, business process simplification, increased customer satisfaction, and high service levels.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method for providing equipment service data, the method comprising:
creating a database containing a plurality of equipment service data elements;
providing an access point for a user to access the database;
verifying that the user is authorized to access the database; and
providing the user with access to the database over a secure network if the user is authorized to access the database, whereby said access provides the user with a virtual office to enter a variety of transactions using data elements in the database.

2. The method of claim 1, wherein the plurality of equipment service data elements comprise date elements regarding at least one of: sales, customer history, equipment history, warranties, service calls, preventive maintenance, repairs, spare parts, accounts receivable, and accounts payable.

3. The method of claim 1, wherein the user comprises at least one of: a customer, a potential customer, and a franchisee.

4. The method of claim 1, wherein the access point is an Internet web site.

5. The method of claim 1, wherein the database is created by a manufacturer of a product, and wherein the user is a service provider authorized by the manufacturer to service the product.

6. A method according to claim 5, wherein the service data elements relate to at least one of: selling maintenance contracts, call management, franchisee management, spare parts sales, warranty management, and knowledge management.

7. A system for providing equipment service data, the system comprising:
a database containing a plurality of equipment service data elements;
an access point for a user to access the database;
means for verifying that the user is authorized to access the database; and
means for providing the user with access to the database over a secure network if the user is authorized to access the database, whereby said access provides the user with a virtual office to enter a variety of transactions using data elements in the database.

8. The system of claim 7, wherein the plurality of equipment service data elements comprise date elements regarding at least one of: sales, customer history, equipment history, warranties, service calls, preventive maintenance, repairs, spare parts, accounts receivable, and accounts payable.

9. The system of claim 7, wherein the user comprises at least one of: a customer, a potential customer, and a franchisee.

10. The system of claim 7, wherein the access point is an Internet web site.

11. The system of claim 7, wherein the database is created by a manufacturer of a product, and wherein the user is a service provider authorized by the manufacturer to service the product.

12. A system according to claim 11, wherein the service data elements relate to at least one of: selling maintenance contracts, call management, franchisee management, spares sales, warranty management, and knowledge management.

13. A program storage device readable by machine, tangibly embodying a program of instructions executable by the machine to perform method steps for providing equipment service data, said method steps comprising:
creating a database containing a plurality of equipment service data elements;
providing an access point for a user to access the database;
verifying that the user is authorized to access the database; and
providing the user with access to the database over a secure network if the user is authorized to access the database, whereby said access provides the user with a virtual office to enter a variety of transactions using data elements in the database.

14. The program storage device of claim 13, wherein the plurality of equipment service data elements comprise date elements regarding at least one of: sales, customer history, equipment history, warranties, service calls, preventive maintenance, repairs, spare parts, accounts receivable, and accounts payable.

15. The program storage device of claim 13, wherein the user comprises at least one of: a customer, a potential customer, and a franchisee.

16. The program storage device of claim 13, wherein the access point is an Internet web site.

17. The program storage device of claim 13, wherein the database is created by a manufacturer of a product, and wherein the user is a service provider authorized by the manufacturer to service the product.

18. A program storage device according to claim 17, wherein the service data elements relate to at least one of: selling maintenance contracts, call management, franchisee management, spare parts sales, warranty management, and knowledge management.

19. A method according to claim 1, wherein:
said access provides a direct information flow from field to a service department, a design department and a quality department; and
the user is a dealer/franchisee, and said access provides the dealer/franchisee with (i) previous repair and customer information as a service call is received, and (ii) a view of recommended solutions related to a problem, and said dealer/franchisee uses said access to enter technical and billing information, and to pass on field information to OEM department.
